(19) United States
(12) Patent Application Publication
(10) Pub. No.: US 2025/0118484 A1
(43) Pub. Date: Apr. 10, 2025

(54) COIL UNIT

(71) Applicant: HONDA MOTOR CO., LTD., Tokyo (JP)

(72) Inventor: Jin Katsuya, Wako-shi (JP)

(21) Appl. No.: 18/895,804

(22) Filed: Sep. 25, 2024

(30) Foreign Application Priority Data
Oct. 5, 2023 (JP) 2023-173523

(51) Int. Cl. H01F 27/30; H02J 50/10

(52) U.S. Cl. CPC H01F 27/30; H02J 50/10

(57) ABSTRACT

A coil unit includes a primary coil or a secondary coil configured to transmit or receive electric power between a power transmitting unit and a power receiving unit by contactless power transmission, and a primary magnetic member or a secondary magnetic member disposed on a rear side of each of the coils. When seen in an axial direction along a central axis, the magnetic member has a primary first portion or a secondary first portion that is located inward from an outer circumferential end portion of each of the coils in a direction perpendicular to the axial direction, and a primary second portion or a secondary second portion that protrudes from each of the first portions outward with respect to the outer circumferential end portion.

### CROSS-REFERENCE TO RELATED APPLICATION

Priority is claimed on Japanese Patent Application No. 2023-173523, filed Oct. 5, 2023, the content of which is incorporated herein by reference.

### BACKGROUND OF THE INVENTION

### Field of the Invention

The present invention relates to a coil unit.

### Description of Related Art

In recent years, research and development has been conducted into charging and supplying power to vehicles equipped with secondary batteries that contribute to energy efficiency, in order to ensure that more people have access to affordable, reliable, sustainable and advanced energy.

Conventionally, in a contactless power transmission system that supplies power from the outside of a vehicle to the vehicle by contactless power transmission, a system is known that includes a backplate made of a magnetic material to induce a magnetic flux around each of coils on the power transmitting and receiving sides (refer to, for example, Patent Document 1).

[Patent Document 1] Japanese Patent Publication No. 7232960

### SUMMARY OF THE INVENTION

In technology related to charging and supplying power to vehicles equipped with secondary batteries, in the contactless power transmission, it is desirable to reduce a magnetic flux (a leakage magnetic flux) other than a main magnetic flux that links with each of the coils on the power transmitting and receiving sides, and to improve a coupling coefficient. For example, as in the above-described conventional contactless power transmission system, simply forming a flat backplate made of a magnetic material into a size that encompasses the coils in a plan view is insufficient to appropriately induce the magnetic flux, resulting in a problem that a core constant of the entire system cannot be improved.

An aspect of the present invention has been made in consideration of the above circumstances, and an object thereof is to provide a coil unit that can improve a core constant of an entire system and can reduce a leakage magnetic flux by appropriately inducing a magnetic flux in contactless power transmission, thereby contributing to energy efficiency.

In order to solve the above problems and achieve the above object, the present invention employs the following aspects.
(1): A coil unit according to an aspect of the present invention includes a coil configured to transmit or receive electric power between a power transmitting unit and a power receiving unit by contactless power transmission, and a magnetic member disposed on a rear side of the coil in a case in which the power transmitting unit and the power receiving unit face each other when seen from the other side, wherein, when seen in an axial direction along a central axis of the coil, the magnetic member has a first portion that is located inward from an outer circumferential end portion of the coil in a perpendicular direction perpendicular to the axial direction, and a second portion that protrudes from the first portion outward with respect to the outer circumferential end portion in the perpendicular direction.
(2): In the aspect (1), the first portion and the second portion may be integral flat plates perpendicular to the axial direction.
(3): In the aspect (1) or (2), the magnetic member may have a third portion that protrudes from the first portion in the axial direction and is inserted into an air-core region of the coil.
(4): In the aspect (3), the third portion may have a frame-shaped wall portion that protrudes from a peripheral edge of a hole that passes through the first portion in the axial direction and is disposed in the air-core region, and a cover portion that closes a protruding side open end of the wall portion.

According to the aspect (1), by providing the magnetic member with a second portion that protrudes outward with respect to the outer peripheral end of the coil, the leakage magnetic field returning to the coil can be spread outward, thereby improving the core constant (=effective magnetic path length/effective cross-sectional area) of the entire system. The directivity of the magnetic flux can be increased and leakage magnetic flux to the surroundings can be reduced by improving the core constant.

In the case of the aspect (2), because the first and second portions are integral flat plates perpendicular to the axial direction, the magnetic flux can be appropriately induced so as to reduce leakage magnetic flux to the surrounding area, compared to, for example, a case in which the second portion is curved toward the opposing side.

In the case of the aspect (3), by providing the magnetic member with a third portion that is inserted into the air-core region of the coil, the distribution of the main magnetic flux between the power transmitting unit and the power receiving unit can be expanded in the center portion in the direction perpendicular to the axial direction, thereby improving the core constant of the entire system. By improving the core constant, the main magnetic flux can be concentrated in the center, and an increase in magnetic flux density on the outside in the direction perpendicular to the axial direction can be curbed.

In the case of the aspect (4), the third portion, which improves the coupling coefficient by being inserted into the hollow core region of the coil, is provided with a wall portion and a lid portion that closes the protruding side open end of the wall portion, thereby curbing an increase in weight compared to, for example, a case in which the third portion is not hollow.

### BRIEF DESCRIPTION OF THE DRAWINGS

FIG. 1 is a diagram showing a configuration of a contactless power transmission system including a coil unit according to an embodiment of the present invention.

FIG. 2 is a diagram showing a configuration of a power transmitting unit and a power receiving unit in the contactless power transmission system according to the embodiment of the present invention.

FIG. 3 is a perspective view showing a primary coil and a primary magnetic member of a power transmitting device and a secondary coil and a secondary magnetic member of a power receiving device in the coil unit according to the embodiment of the present invention.

FIG. 4 is a diagram showing the primary coil and the primary magnetic member of the power transmitting device and the secondary coil and the secondary magnetic member of the power receiving device in the coil unit according to the embodiment of the present invention when seen in a direction perpendicular to an axial direction.

FIG. 5 is a diagram showing an example of a magnetic field in the coil unit according to the embodiment of the present invention when seen in the direction perpendicular to the axial direction.

FIG. 6 is a contour chart showing an example of a magnetic flux density distribution in the coil unit according to the embodiment of the present invention when seen in the direction perpendicular to the axial direction.

FIG. 7 is a contour chart showing an example of the magnetic flux density distribution in the coil unit according to the embodiment of the present invention, viewed from a direction perpendicular to the axial direction.

### DETAILED DESCRIPTION OF THE INVENTION

Hereinafter, a coil unit according to an embodiment of the present invention will be described with reference to the accompanying drawings.

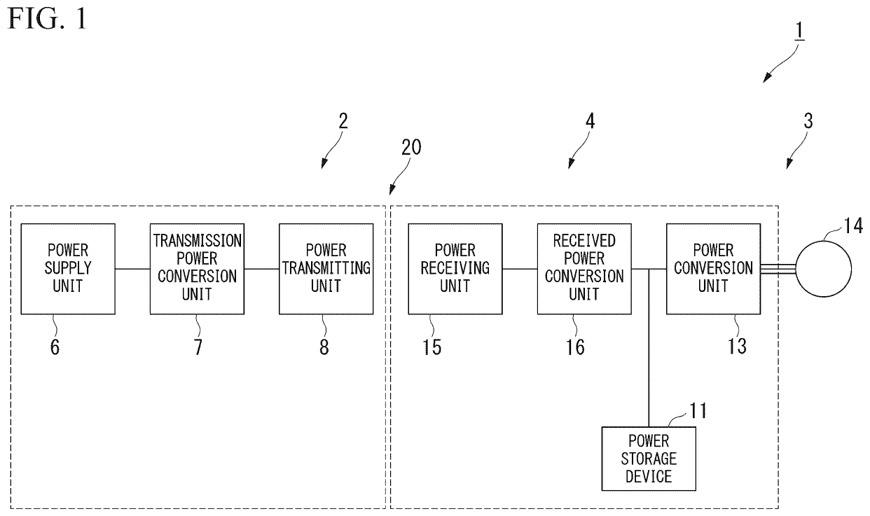

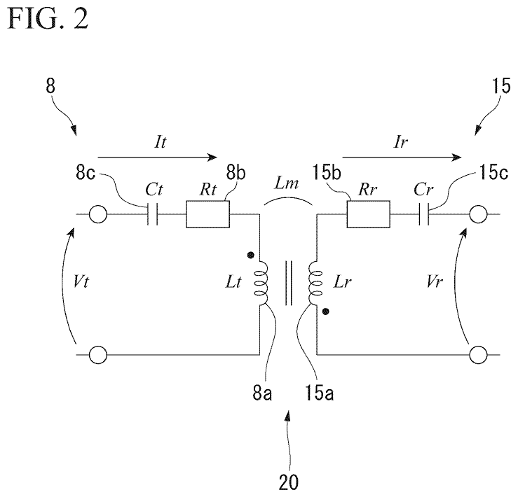

FIG. 1 is a diagram showing a configuration of a contactless power transmission system 1 including a coil unit 20 according to an embodiment. FIG. 2 is a diagram showing a configuration of a power transmitting unit 8 and a power receiving unit 15 in the contactless power transmission system 1 according to the embodiment.

The coil unit 20 of the embodiment constitutes a part of the contactless power transmission system 1 that supplies power from the outside of a moving body such as a vehicle to the moving body by contactless power transmission. The vehicle is, for example, an electric vehicle such as an electric car, a hybrid vehicle, or a fuel cell vehicle.

### Contactless Power Transmission System

As shown in FIGS. 1 and 2, the contactless power transmission system 1 of the embodiment includes a power transmitting device 2 that is installed, for example, on a road on which the vehicle runs, or the like, and a drive control device 3 and a power receiving device 4 that are mounted in the moving object such as a vehicle. The contactless power transmission system 1 of the embodiment may include at least only components (for example, the drive control device 3 and the power receiving device 4) mounted in the moving object or only components (for example, the power transmitting device 2) outside the moving object, and may perform the contactless power transmission by combining the contactless power transmission system 1 with other components.

The power transmitting device 2 includes, for example, a power supply unit 6, a transmission power conversion unit 7, and a power transmitting unit 8. The power transmitting device 2 may include at least a plurality of power transmitting units 8 in a predetermined coupling section on a road on which the vehicle runs, for example.

The power supply unit 6 includes, for example, an AC power supply such as a commercial power supply, an AC-DC converter that converts AC power into DC power, and a power smoothing capacitor. The power supply unit 6 converts the AC power supplied from the AC power supply into DC power by the AC-DC converter.

The transmission power conversion unit 7 includes, for example, an inverter that converts DC power into AC power. The inverter of the transmission power conversion unit 7 includes a first bridge circuit formed by a plurality of switching elements and rectifier elements that are bridge-connected in two phases, for example, and a voltage smoothing capacitor. Each of the switching elements is, for example, a transistor such as a metal oxide semiconductor field effect transistor (MOSFET) made of silicon carbide (SiC). The plurality of switching elements are high and low arm transistors that form a pair for each phase. The rectifier elements are, for example, reflux diodes connected in parallel to the respective transistors. The voltage smoothing capacitor is connected in parallel to the first bridge circuit.

The power transmitting unit 8 transmits power by changing a high-frequency magnetic field, for example, through magnetic field coupling such as magnetic resonance or electromagnetic induction. As shown in FIG. 2, the power transmitting unit 8 includes, for example, a resonant circuit formed by a primary coil 8a, a primary resistor 8b, and a primary capacitor 8c connected in series. The power transmitting unit 8 includes, for example, a sensor such as a current sensor that detects a current It flowing through the resonant circuit.

For example, the power transmitting device 2 performs the power transmission to the power receiving device 4 of the moving body such as a vehicle by controlling on (conducting) and off (blocking) switching of each of the switching elements of the transmission power conversion unit 7 in accordance with information on a preset drive frequency or a required frequency received from the power receiving device 4.

As shown in FIGS. 1 and 2, the drive control device 3 of the moving body such as a vehicle includes, for example, a power storage device 11, a power conversion unit 13, and a rotating electric machine 14. The power receiving device 4 of the moving body includes, for example, the power receiving unit 15 and a received power conversion unit 16.

The power storage device 11 is connected to the power conversion unit 13 and the received power conversion unit 16 which will be described below. The power storage device 11 is charged by power transmitted in a contactless manner from the power transmitting device 2 outside the moving body such as a vehicle. The power storage device 11 transmits and receives power to/from the rotating electric machine 14 via the power conversion unit 13.

The power storage device 11 includes a battery, such as a lithium ion battery, a current sensor that detects a current of the battery, and a voltage sensor that detects a voltage of the battery.

The power conversion unit 13 is connected to the rotating electric machine 14. The power conversion unit 13 includes, for example, a power converter that converts between DC power and AC power. The power converter includes, for example, a second element module and a voltage smoothing capacitor.

The second element module includes, for example, a second bridge circuit formed by a plurality of switching elements and rectifier elements that are bridge-connected in three phases. Each of the switching elements is, for example, a transistor such as a MOSFET made of SiC, or the like. The plurality of switching elements are high arm and low arm transistors that form a pair in each phase. The rectifier elements are, for example, reflux diodes connected in parallel to the respective transistors. The voltage smoothing capacitor is connected in parallel to the second bridge circuit.

The second element module controls an operation of the rotating electric machine 14 by receiving and transmitting electric power. For example, when the rotating electric machine 14 is powered, the second element module converts the DC power input from positive and negative DC terminals into three-phase AC power and supplies the three-phase AC power to the rotating electric machine 14 from three-phase AC terminals. The second element module generates a rotational driving force by sequentially commutating a current to three-phase stator windings of the rotating electric machine 14.

For example, during regeneration of the rotating electric machine 14, the second element module converts the three-phase AC power input from the three-phase stator windings into DC power by driving the switching elements of each phase on (conducting) and off (blocking) in synchronization with rotation of the rotating electric machine 14. The second element module is capable of supplying the DC power converted from the three-phase AC power to the power storage device 11.

The rotating electric machine 14 is, for example, a three-phase AC brushless DC motor provided for driving the moving body such as a vehicle. The rotating electric machine 14 includes a rotor having a permanent magnet for a field magnet, and a stator having a three-phase stator winding that generates a rotating magnetic field for rotating the rotor. The three-phase stator winding is connected to a three-phase AC terminal 13d of the power conversion unit 13.

The rotating electric machine 14 generates a rotational driving force by performing a powering operation with the electric power supplied from the power conversion unit 13. For example, when the rotating electric machine 14 can be connected to wheels of a vehicle, the rotating electric machine 14 generates a driving force for running the vehicle by performing a powering operation with electric power supplied from the power conversion unit 13. The rotating electric machine 14 may generate electric power by performing a regenerative operation with rotational power input from the wheels side of the vehicle. When the rotating electric machine 14 can be connected to an internal combustion engine of a vehicle, the rotating electric machine 14 may generate electric power using power of the internal combustion engine.

The power receiving unit 15 is connected to the received power conversion unit 16. The power receiving unit 15 receives electric power by a change in a high-frequency magnetic field transmitted from the power transmitting unit 8 due to magnetic field coupling such as magnetic resonance or electromagnetic induction. As shown in FIG. 2, the power receiving unit 15 includes, for example, a resonant circuit formed by a secondary coil 15a, a secondary resistor 15b, and a secondary capacitor 15c which are connected in series. The power receiving unit 15 includes, for example, a sensor such as a current sensor that detects a current Ir flowing through the resonant circuit.

The received power conversion unit 16 shown in FIGS. 1 and 2 is connected to the power conversion unit 13. The received power conversion unit 16 is equipped with a so-called full bridgeless type (or bridgeless and totem pole type) power factor correction (PFC) circuit that converts AC power into DC power. The so-called bridgeless PFC is a PFC that does not have a bridge rectifier configured of plurality of bridge-connected diodes, and the so-called totem-pole PFC is a PFC that has a pair of switching elements of the same conductivity type connected in series (totem-pole connected) in the same direction.

The received power conversion unit 16 includes, for example, a third bridge circuit formed by a plurality of switching elements and rectifier elements that are bridge-connected in two phases, and a voltage smoothing capacitor. Each of the switching elements is, for example, a transistor such as a MOSFET made of SiC, or the like. The plurality of switching elements are high arm and low arm transistors that form a pair in each phase. The rectifier elements are, for example, reflux diodes connected in parallel to the respective transistors. The voltage smoothing capacitor is connected in parallel to the third bridge circuit.

For example, the power receiving device 4 equipped with the power receiving unit 15 and the received power conversion unit 16 receives electric power transmitted from the power transmitting device 2 by controlling the on (conducting) and off (blocking) switching of each of the switching elements of the received power conversion unit 16 in accordance with information on a frequency of power transmission by the power transmitting device 2.

### Coil Unit

The coil unit 20 of the embodiment constitutes, for example, at least one of the power transmitting unit 8 and the power receiving unit 15.

Hereinafter, as the coil unit 20 of the embodiment, for example, a power transmission side coil unit 20a constituting the power transmitting unit 8 and a power reception side coil unit 20b constituting the power receiving unit 15 will be described.

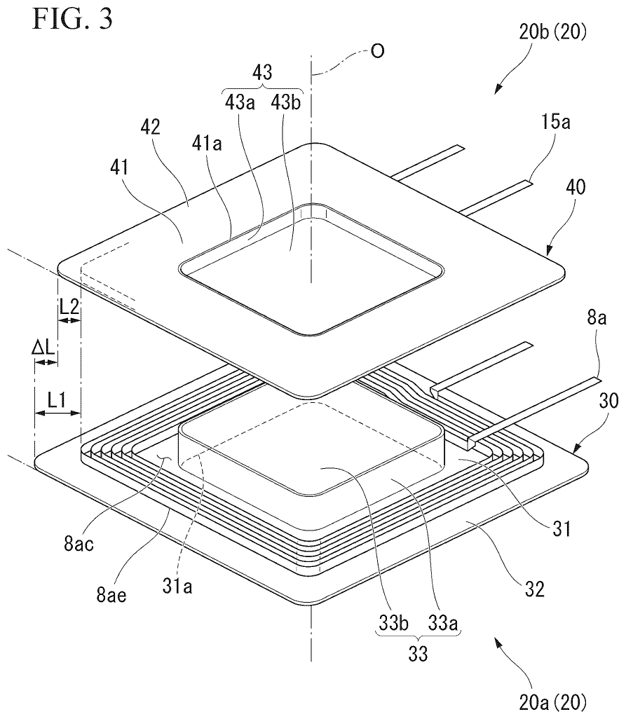

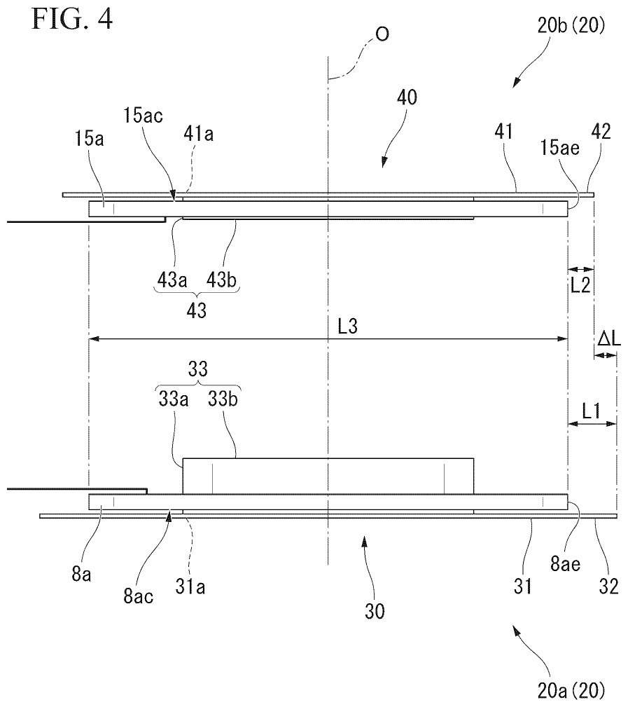

FIG. 3 is a perspective view showing the primary coil 8a and the primary magnetic member 30 of the power transmitting device 2 and the secondary coil 15a and the secondary magnetic member 40 of the power receiving device 4 in the coil unit 20 of the embodiment. FIG. 4 is a diagram of the primary coil 8a and the primary magnetic member 30 of the power transmitting device 2 and the secondary coil 15a and the secondary magnetic member 40 of the power receiving device 4 in the coil unit 20 of the embodiment when seen in a direction perpendicular to an axial direction.

As shown in FIGS. 3 and 4, the power transmission side coil unit 20a (20) of the embodiment includes, for example, the primary coil 8a and the primary magnetic member 30. The power reception side coil unit 20b (20) of the embodiment includes, for example, the secondary coil 15a and a secondary magnetic member 40.

Each of the primary coil 8a and the secondary coil 15a is formed to have, for example, a rectangular spiral shape.

Each of the primary magnetic member 30 and the secondary magnetic member 40 is formed to have, for example, a rectangular flat plate shape having a box-shaped convex portion. Each of the primary magnetic member 30 and the secondary magnetic member 40 is formed of a magnetic material with a relatively high magnetic permeability, such as a non-directional (isotropic) magnetic material like ferrite, or a directional (anisotropic) magnetic material like an electromagnetic steel plate such as a silicon steel plate, or a soft magnetic material like a nanocrystalline soft magnetic material. For example, when the power transmitting unit 8 and the power receiving unit 15 face each other, the primary magnetic member 30 is disposed behind the primary coil 8a when seen from the power receiving unit 15 side. For example, when the power transmitting unit 8 and the power receiving unit 15 face each other, the secondary magnetic member 40 is disposed behind the secondary coil 15a when seen from the power transmitting unit 8 side.

The primary magnetic member 30 includes, for example, a primary first portion 31, a primary second portion 32, and a primary third portion 33.

The primary first portion 31 and the primary second portion 32 are formed to have, for example, an integral flat plate shape perpendicular to the axial direction along a central axis O of the primary coil 8a.

The primary first portion 31 is, for example, disposed inward with respect to an outer circumferential end portion 8ae of the primary coil 8a in the direction perpendicular to the axial direction when seen in the axial direction along the central axis O of the primary coil 8a.

The primary side second portion 32 protrudes from the primary first portion 31 outward with respect to the outer circumferential end portion 8ae by a predetermined first length L1 in the direction perpendicular to the axial direction, for example, when viewed in the axial direction along the central axis O of the primary coil 8a.

The primary third portion 33 protrudes, for example, in the axial direction from a center portion of the primary first portion 31 and is inserted into an air-core region 8ac of the primary coil 8a. A protruding height of the primary third portion 33 is set, for example, according to a thickness of the primary coil 8a in the axial direction.

The primary third portion 33 includes, for example, a primary wall portion 33a and a primary cover portion 33b. The primary wall portion 33a has, for example, a frame shape which protrudes from a peripheral edge of a hole 31a that passes through the primary first portion 31 in the axial direction, and is disposed in the air-core region 8ac of the primary coil 8a. The primary cover portion 33b is formed to have, for example, a flat plate shape that closes a protruding side open end of the primary wall portion 33a.

The secondary magnetic member 40 includes, for example, a secondary first portion 41, a secondary second portion 42, and a secondary third portion 43.

The secondary first portion 41 and the secondary second portion 42 is formed to have, for example, an integral flat plate shape perpendicular to the axial direction along a central axis O of the secondary coil 15a.

For example, when seen in the axial direction along the central axis O of the secondary coil 15a, the secondary first portion 41 is disposed inward with respect to an outer circumferential end portion 15ae of the secondary coil 15a in the direction perpendicular to the axial direction.

The secondary second portion 42 protrudes from the secondary first portion 41 outward with respect to the outer circumferential end portion 15ae by a predetermined second length L2 in the direction perpendicular to the axial direction, for example, when seen in the axial direction along the central axis O of the secondary coil 15a.

The secondary third portion 43 protrudes, for example, from a center portion of the secondary first portion 41 in the axial direction and is inserted into an air-core region 15ac of the secondary coil 15a. A protruding height of the secondary third portion 43 is set according to, for example, a thickness of a paving material, such as concrete or asphalt, to which the power transmitting unit 8 is fixed on a road on which a vehicle or the like runs.

The secondary third portion 43 includes, for example, a secondary wall portion 43a and a secondary cover portion 43b. The secondary wall portion 43a is formed to have, for example, a frame shape that protrudes from a peripheral edge of a hole 41a that passes through the secondary first portion 41 in the axial direction and is disposed in the air-core region 15ac of the secondary coil 15a.

The secondary cover portion 43b has, for example, a flat plate shape that closes a protruding side open end of the secondary wall portion 43a.

For example, when an outer circumferential size (such as width L3 in the direction perpendicular to the axial direction) of the primary coil 8a and the secondary coil 15a is the same, the predetermined first length L1 is larger than the predetermined second length L2 by a predetermined length ΔL.

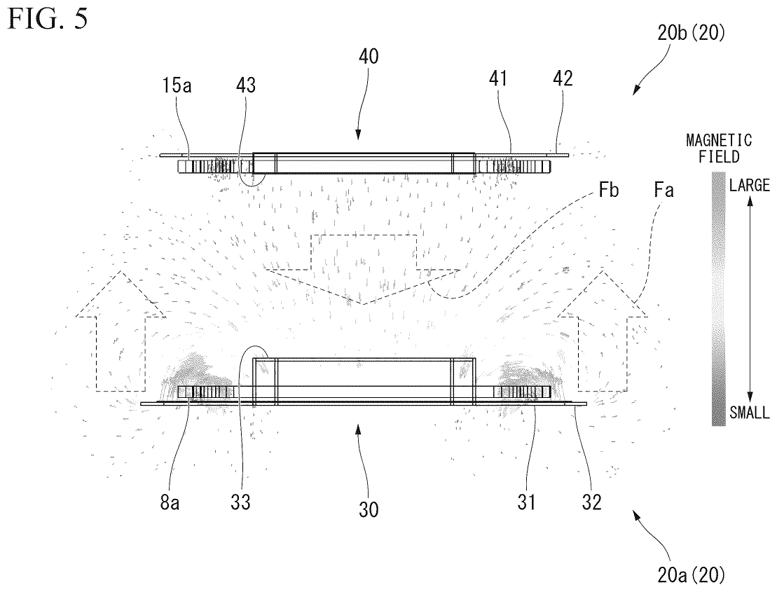

FIG. 5 is a diagram showing an example of a magnetic field in the coil unit 20 according to the embodiment, when seen in the direction perpendicular to the axial direction.

As shown in FIG. 5, since the primary magnetic member 30 and the secondary magnetic member 40 have the primary second portion 32 and the secondary second portion 42, it is recognized that a distribution of a leakage magnetic flux Fa that returns to each of the coils 8a and 15a (particularly, the primary coil 8a, and the like) without interlinking with the primary coil 8a and the secondary coil 15a spreads laterally (outward in the direction perpendicular to the axial direction).

Since the primary magnetic member 30 and the secondary magnetic member 40 have the primary third portion 33 and the secondary third portion 43, it is recognized that a distribution of a main magnetic flux Fb interlinked with the primary coil 8a and the secondary coil 15a spreads in the direction perpendicular to the axial direction at the center portion.

It is recognized that, since a distribution of a magnetic flux density between the primary coil 8a and the secondary coil 15a becomes thinner, a core constant (=effective magnetic path length/effective cross-sectional area) is enhanced, and since directivity of the magnetic flux increases, the leakage magnetic flux to the surroundings is reduced.

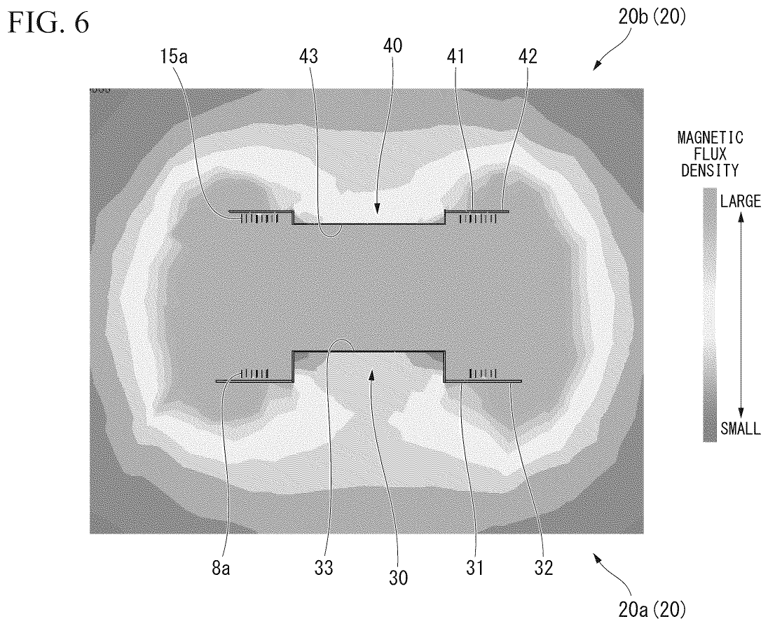

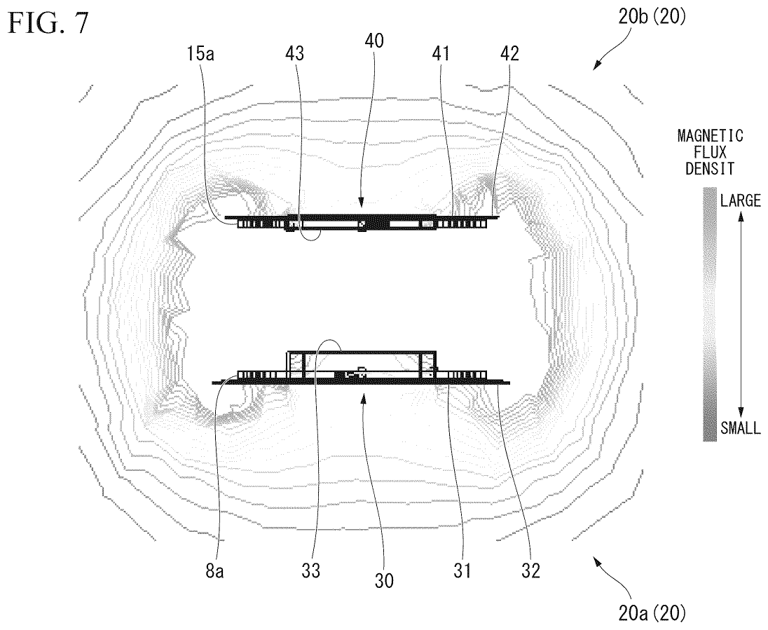

FIG. 6 is a contour chart showing an example of the distribution of the magnetic flux density in the coil unit 20 according to the embodiment, when seen in the direction perpendicular to the axial direction. FIG. 7 is a contour chart showing an example of the distribution of the magnetic flux density in the coil unit 20 according to the embodiment, when seen in the direction perpendicular to the axial direction.

As shown in FIGS. 6 and 7, it is recognized that since the primary magnetic member 30 and the secondary magnetic member 40 have the primary second portion 32, the secondary second portion 42, the primary third portion 33, and the secondary third portion 43, the main magnetic flux is concentrated in the center portion, and an increase in the magnetic flux density on the outside in the direction perpendicular to the axial direction is curbed.

As described above, according to the coil unit 20 of the embodiment, since the magnetic members 30 and 40 respectively has the second portions 32 and 42 that protrude outward with respect to the outer circumferential end portions 8ae and 15ae of the coils 8a and 15a, the leakage magnetic field returning to each of the coils 8a and 15a can be spread outward, and the core constant of the system as a whole can be improved. By improving the core constant, the directivity of the magnetic flux can be increased and the leakage magnetic flux to the surroundings can be reduced.

Since the first portions 31 and 41 and the second portions 32 and 42 are integral flat plates perpendicular to the axial direction, the magnetic flux can be appropriately guided so as to reduce the leakage magnetic flux to the surrounding area, compared to, for example, a case in which each of the second portions 32 and 42 is curved toward the opposing side (the power transmitting unit 8 side or the power receiving unit 15 side).

Since the magnetic members 30 and 40 respectively have the third portions 33 and 43 inserted into the air-core regions 8ac and 15ac of the coils 8a and 15a, the distribution of the main magnetic flux between the power transmitting unit 8 and the power receiving unit 15 can be spread in the center portion in the direction perpendicular to the axial direction, and the core constant of the system as a whole can be improved. By improving the core constant, the main magnetic flux can be concentrated in the center portion, and an increase in the magnetic flux density on the outside in the direction perpendicular to the axial direction can be curbed.

Since each of the third portions 33 and 43 which improves the coupling coefficient by being inserted into the air-core regions 8ac and 15ac has each of the wall portions 33a and 43a and each of the lid portions 33b and 43b that closes the protruding side opening ends of the wall portions 33a and 43a, it is possible to curb an increase in a weight compared to, for example, a case in which the third portion is not hollow.

### Modified Example

In the above-described embodiment, although it has been described that the predetermined first length L1 of the primary second portion 32 was greater than the predetermined second length L2 of the secondary second portion 42 by the predetermined length ΔL, the present invention is not limited thereto. It is preferable to form the primary second portion 32 on the power transmission side relatively large in order to reduce the leakage magnetic flux, but the predetermined first length L1 and the predetermined second length L2 may be the same, or the predetermined second length L2 may be greater than the predetermined first length L1.

The embodiments of the present invention are presented as examples and are not intended to limit the scope of the invention. The embodiments can be implemented in various other forms, and various omissions, substitutions, and modifications can be made without departing from the spirit of the invention. The embodiments and variations thereof are included in the scope of the invention and equivalents thereof as described in the claims, as well as in the scope and spirit of the invention.

What is claimed is:

1. A coil unit comprising:
a coil configured to transmit or receive electric power between a power transmitting unit and a power receiving unit by contactless power transmission; and
a magnetic member disposed on a rear side of the coil in a case in which the power transmitting unit and the power receiving unit face each other when seen from the other side,
wherein, when seen in an axial direction along a central axis of the coil, the magnetic member has a first portion that is located inward from an outer circumferential end portion of the coil in a perpendicular direction perpendicular to the axial direction, and a second portion that protrudes from the first portion outward with respect to the outer circumferential end portion in the perpendicular direction.

2. The coil unit according to claim 1, wherein the first portion and the second portion are integral flat plates perpendicular to the axial direction.

3. The coil unit according to claim 1, wherein the magnetic member has a third portion that protrudes from the first portion in the axial direction and is inserted into an air-core region of the coil.

4. The coil unit according to claim 3, wherein the third portion has a frame-shaped wall portion that protrudes from a peripheral edge of a hole that passes through the first portion in the axial direction and is disposed in the air-core region, and a cover portion that closes a protruding side open end of the wall portion.
